(19) United States
(12) Patent Application Publication
(10) Pub. No.: US 2012/0095771 A1
(43) Pub. Date: Apr. 19, 2012

(54) SYSTEM AND METHOD FOR SENDING, RECEIVING AND UPDATIING BUSINESS CARD BETWEEN ELECTRONIC DEVICES

(75) Inventors: HAN-CHE WANG, Tu-Cheng (TW); KUAN-HONG HSIEH, Tu-Cheng (TW); HUA-DONG CHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/048,827

(22) Filed: Mar. 15, 2011

(30) Foreign Application Priority Data
Oct. 14, 2010 (CN) 201010507137.8

(51) Int. Cl. G06Q 99/00

(52) U.S. Cl. 705/1.1

(57) ABSTRACT

A system for updating, sending and receiving a business card between electronic devices is provided. The system includes an input unit for a user to fill contact information, an identifying module, a template creating module, a verifying module, a first and second updating modules and a comparing module. The identifying module identifies whether an electronic device is used for the first time and whether a SIM card is being used for the first time with the electronic device. The template creating module creates the template of the business card. The verifying module prompts to input a password and verifies it. The first updating module prompts the sender to update contact information and creates the business card. The comparing module determines whether the communication list comprises a contact number which is the same as the old contact number in the business card. The second updating module updates the communication list.

### BACKGROUND

1. Technical Field

The present disclosure relates to a system and a method for sending, receiving and updating a business card between electronic devices.

2. Description of Related Art

Nowadays, a great number of electronic devices are developed for facilitating communications among people. Those electronic devices typically include mobile phones and computers. Many of those electronic devices also help users to keep a record of their contacts. The record generally includes the contact information (i.e., telephone numbers). Nowadays, when the contact information changes, users (hereinafter “the senders”) often distribute business cards containing changed information using portable electronic devices, such as mobile phones to their contacts (hereinafter “the recipients”). On a business card edited as a text file transmitted with SMS (Short Message Service), the contact information usually includes, such information as, a business name, a phone number, an address and other information of the sender. The recipient can manually update old contact information or add new contact information of the sender when the business card of the sender is received. Although senders can send their business cards to more than one recipients at a time, the senders have to edit their business cards and the recipients have to manually update the contact information of the sender, which is time consuming and inconvenient for users.

Therefore, what is needed is a system and a method for sending, receiving and updating a business card between electronic devices to alleviate the limitations described above.

### BRIEF DESCRIPTION OF THE DRAWINGS

The components in the drawings are not necessarily drawn to scale, the emphasis instead being placed upon clearly illustrating the principles of a system and a method for sending, receiving and updating a business card between electronic devices. Moreover, in the drawings, like reference numerals designate corresponding parts throughout the several views.

FIG. 1 is a schematic, block diagram illustrating a system for sending, receiving and updating a business card between electronic devices, according to an exemplary embodiment.

FIG. 2 is a flowchart of updating, sending and receiving a business card between electronic devices of FIG. 1, in accordance with the exemplary embodiment.

FIG. 3 is a flowchart of receiving and updating a business card received between electronic devices of FIG. 1, in accordance with the exemplary embodiment.

FIG. 4 is a sub-flowchart of updating the business card received between electronic devices of FIG. 3.

### DETAILED DESCRIPTION

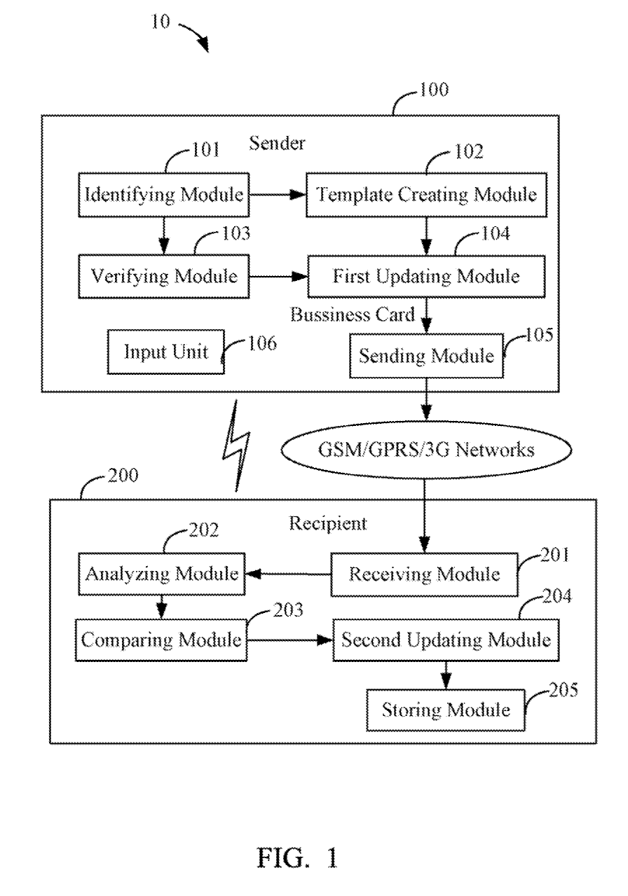

Referring to FIG. 1, a system 10 for sending, receiving, and updating a business card between electronic devices is disclosed as an exemplary embodiment. The system 10 includes a sender 100 and a recipient 200. Both the sender 100 and the recipient 200 include an electronic device with updating business card function. The electronic device is a mobile communication apparatus such as a mobile phone or a personal digital assistant (PDA).

The sender 100 includes an identifying module 101, a template creating module 102, a verifying module 103, a first updating module 104, a sending module 105, and an input unit 106. The input unit 101 is configured for a user to fill in contact information.

The identifying module 101 is configured for identifying whether an electronic device is used for the first time and generating a first identifying signal to the template creating module 102. In this embodiment, the identifying module 101 confirms the electronic device is being used for the first time when the factory default setting of the electronic device has not been modified. The identifying module 101 is also configured for identifying whether a subscriber identity module (SIM) card in the electronic device is used being for the first time with the electronic device. The identifying module 101 sends a second identifying signal to the verifying module 103 when the SIM card inserted in the electronic device is used being for the first time with the electronic device. In this embodiment, the identifying module 101 confirms the SIM card is being used for the first time with the electronic device when no information from the SIM card is stored in the electronic device.

The template creating module 102 is configured for creating a template of the business card when the first identifying signal has been received. In the embodiment, the template of the business card shows a number of items including a name column and a contact number column. The name column includes the user's name of the sender 100. The contact number column includes the user's new and old contact numbers of the sender 100. In an alternative embodiment, the template of the business card may also include other contact information columns of the user of the sender 100, such as an address column, an e-mail column, and a company column. The address column, the e-mail column and the company column each correspondingly includes a new address, a new e-mail and a new company hiring the user of the sender 100. The template creating module 102 is also configured for transmitting the created template of the business card to the first updating module 104.

The verifying module 103 is configured for prompting the user to input a password when the first or second identifying signal is received. The verifying module 103 is also configured for verifying the password, and informing the first updating module 104 when the password passes the verification. The password is preset by the user, for confirming the authority of sending the business card to the contacts listed in the communication list stored in the electronic device.

The first updating module 104 is configured for creating an updating notice to prompt the user to update contact information in the contact information columns of the template of the business card after the password passes the verification executed by the verifying module 103. In this embodiment, the updating notice may be dialog boxes corresponding to the information columns, and the dialog boxes are displayed in turn to guide the user to fill in information. In an alternative embodiment, the updating notice is a dialog box displaying the template of the business card for the user to fill in information.

The first updating module 104 is further configured for creating a business card according to the contact information the user updated. That is, after the user updates the contact information to the template of the business card, the first updating module 104 creates a business card, which includes the name, the new and old contact numbers, the e-mail and the company of the user for the sender 100. In the embodiment, the new and old contact numbers are required items. The old contact number is used for verifying whether the recipient 200 stores the information of the sender 100 after the business card is received by the recipient 200. In this embodiment, when the old contact number included in the business card is also included in the communication list stored in the electronic device of the recipient 200, the recipient 200 confirms the business card belongs to a contact of the recipient 200 and updates the contact information of the contact according to the business card.

The sending module 105 is configured for sending the business card edited as a text file to the one or more contacts selected by the sender 100. The business card is transmitted via one of the wide area communication networks, such as the GSM, the GPS, or the 3G communication networks. In an alternative embodiment, the business card is transmitted via one of the local communication manners, such as Bluetooth or WIFI. The sending module 105 may further be configured for automatically fetching the communication list stored in the electronic device and sending the business card to all of the contacts in the communication list. Thus, there is no need for the user of the sender 100 to select a list of contacts to send the business card to.

The recipient 200 includes a receiving module 201, an analyzing module 202, a comparing module 203, a second updating module 204 and a storing module 205.

The receiving module 201 is configured for receiving the business card of the sender 100 transmitted by the wireless networks such as GSM, GPRS or 3G.

The analyzing module 202 is configured for converting the information of the business card to recognizable codes of the recipient 200, and analyzing the information of the information columns.

The comparing module 203 is configured for determining whether the old contact number in the business card is also included in the communication list of the recipients 200 according to the analyzed information provided by the analyzing module 202. The comparing module 203 transmits the comparison results to the second updating module 204. The comparing module 203 is also configured for determining whether other information columns except the name column and the old contact number column of the business card is included in the communication list. The comparing module 203 also transmits the comparison results to the second updating module 204.

The second updating module 204 is configured for updating the communication list of the recipient 200 according to the comparison results transmitted from the comparing module 203. In this embodiment, when the old contact number in the business card is also included in the communication list of the recipient 200, the second updating module 204 confirms the business card belongs to the contact in the communication list of the recipient 200 whose contact number is also included in the business card. That is, the contact and the sender 100 are the same person. And the second updating module 204 updates the information of the contact (sender) in the communication list of the recipient 200 according to the contact information on the business card. When the old contact number in the business card is not included in the communication list of the recipient 200, the second updating module 204 adds a new contact in the communication list of the recipient 200 and records the corresponding information except the old contact number on the business card under the new contact.

In the embodiment, the second updating module 204 updates the information in the communication list of the recipient 200 in the following circumstances: replacing the old contact number on the communication list of the recipient 200 with the new contact number of the sender 100, determining whether the information columns except the name column on the communication list of the recipient 200 are null. When the information columns except the name column are null, it copies the information in the information columns of the business card to the information columns of the contact on the communication list of the recipient 200. When the information columns except the names in the column are not null, it replaces the information on the communication list of the recipient 200 with the information on the business card.

In another embodiment, the second updating module 204 is also configured for popping up a dialog box showing the information on the business card of the sender 100, then prompting the recipient 200 to confirm whether to update the communication list, and updates the communication list when the recipient 200 confirms it.

The storing module 205 is configured for storing the communication list updated by the second updating module 205.

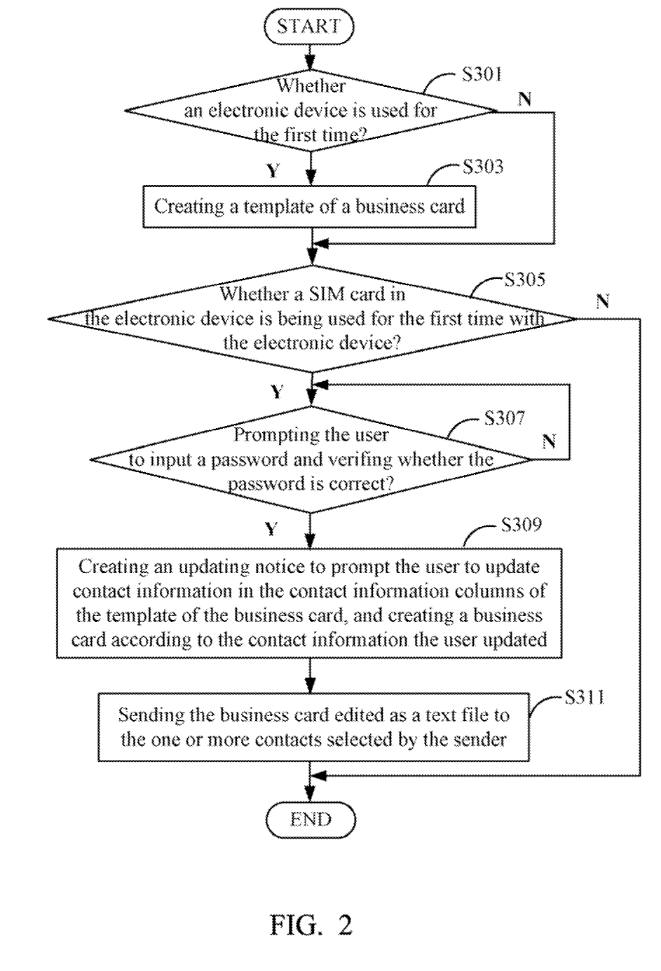

Together referring to FIGS. 1 and 2, FIG. 2 shows a flowchart of the sender 100 updating and sending a business card to the recipient 200 between electronic devices of FIG. 1. The method includes the following steps, each of which is tied to various components contained in the system 10 as shown in FIG. 1.

In step S301, the identifying module 101 identifies whether an electronic device is used for the first time. If yes, the process goes to step S303, otherwise, the process goes to step S305. In the embodiment, the identifying module 101 confirms the electronic device is used for the first time when the factory default setting of the electronic device has not been modified.

In step S303, the template creating module 102 creates a template of a business card. In the embodiment, the template of the business card includes a name column and a contact number column. The name column includes the user's name of the sender 100. The contact number column includes the user's new and old contact numbers of the sender 100. In an alternative embodiment, the template of the business card may also include other contact information columns of the user of the sender 100, such as an address column, an e-mail column, and a company column. The address column, the e-mail column, and the company column each correspondingly include a new address, a new e-mail and a new company hiring the user of the sender 100.

In step S305, the identifying module 101 identifies whether a SIM card in the electronic device is being used for the first time with the electronic device. If yes, the process goes to step S307, otherwise, the process ends. The identifying module 101 confirms the SIM card is being used for the first time with the electronic device when no information from the SIM card is stored in the electronic device.

In step S307, the verifying module 103 prompts the user to input a password and verifies whether the password is correct. If the password is invalid, the process ends, and if the password is valid, the process goes to step S309. The password is preset by the user, for confirming the authority of sending the business card to the contacts listed in the communication list stored in the electronic device. In another embodiment, the process ends only when the password is continually input more than a predetermined times by the user. Preferably, the predetermined times are three.

In Step S309, the first updating module 104 creates an updating notice to prompt the user to update contact information in the contact information columns of the template of the business card, and creates a business card according to the contact information the user updated. The updating notice may be dialog boxes corresponding to the information columns, and the dialog boxes are displayed in turn to guide the user to fill in information. In an alternative embodiment, the updating notice is a dialog box displaying the template of the business card for the user to fill in information. After the user updates the contact information to the template of the business card, the first updating module 104 creates a business card, which includes the name, the new and old contact numbers, the e-mail and the company of the user of the sender 100. In the embodiment, the new and old contact numbers are required items. The old contact number is used for verifying whether the recipient 200 stores the information of the sender 100 after the business card is received by the recipient 200. In this embodiment, when the old contact number included in the business card is also included in the communication list stored in the electronic device of the recipient 200, the recipient 200 confirms the business card belongs to a contact of the recipient 200 and updates the contact information of the contact according to the business card.

In Step S311, the sending module 105 sends the business card edited as a text file to the one or more contacts selected by the sender 100. In the embodiment, the business card is transmitted via one of the wide area communication networks, such as the GSM, the GPS, or the 3G communication networks. In an alternative embodiment, the business card is transmitted via one of the local communication modes, such as Bluetooth or WIFI. The sending module 105 may be further configured for automatically fetching the communication list stored in the electronic device and sending the business card to all of the contacts in the communication list. Thus there is no need for the user of the sender 100 to select a list of contacts to send the business card to.

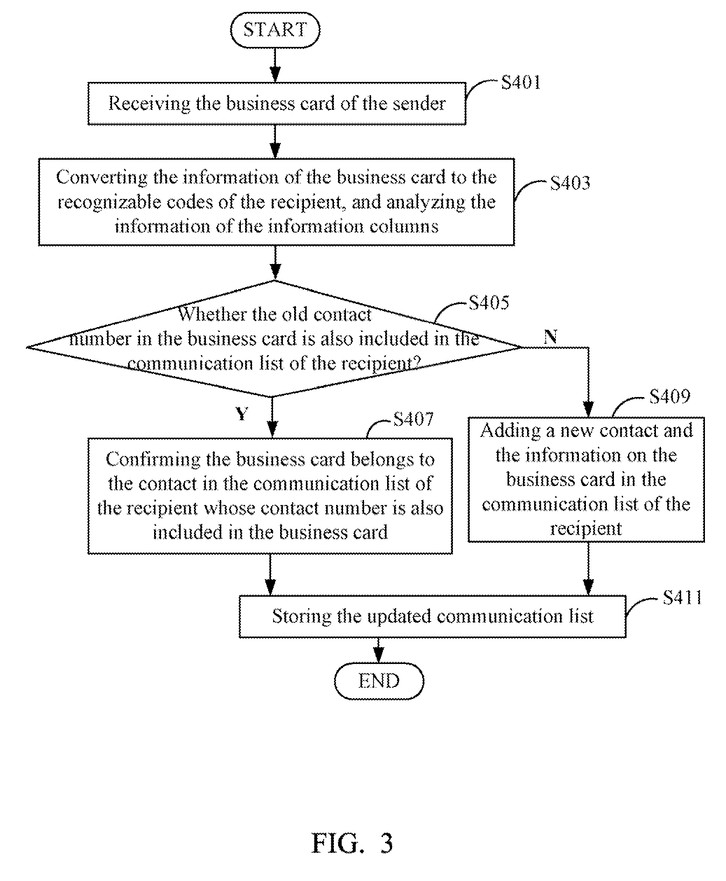

Together referring to FIGS. 1 and 3, FIG. 3 shows a flowchart of the recipient 200 receiving and updating a business card sent from the sender 100 between electronic devices of FIG. 1. The method includes the following steps, each of which is tied to various components contained in the system 10 as shown in FIG. 1.

In step S401, the receiving module 201 receives the business card of the sender 100 transmitted by the wireless networks such as GSM, GPRS or 3G.

In step S403, the analyzing module 202 converts the information of the business card to the recognizable codes of the recipient 200, and analyzes the information of the information columns.

In step S405, the comparing module 203 determines whether the old contact number in the business card is also included in the communication list of the recipient 200 according to the analyzed information provided by the analyzing module 202. If yes, the process goes to step S407, otherwise, the process goes to S409.

In step S407, the second updating module 204 confirms the business card belongs to the contact in the communication list of the recipient 200 whose contact number is also included in the business card. That is, the contact and the sender 100 are the same person. And the second updating module 204 updates the information of the contact (sender) in the communication list of the recipient 200 according to the contact information on the contact card.

In step S409, the second updating module 204 adds a new contact and the corresponding information on the business card in the communication list of the recipient 200.

In step S411, the second updating module 204 stores the updated communication list in the storing module 205.

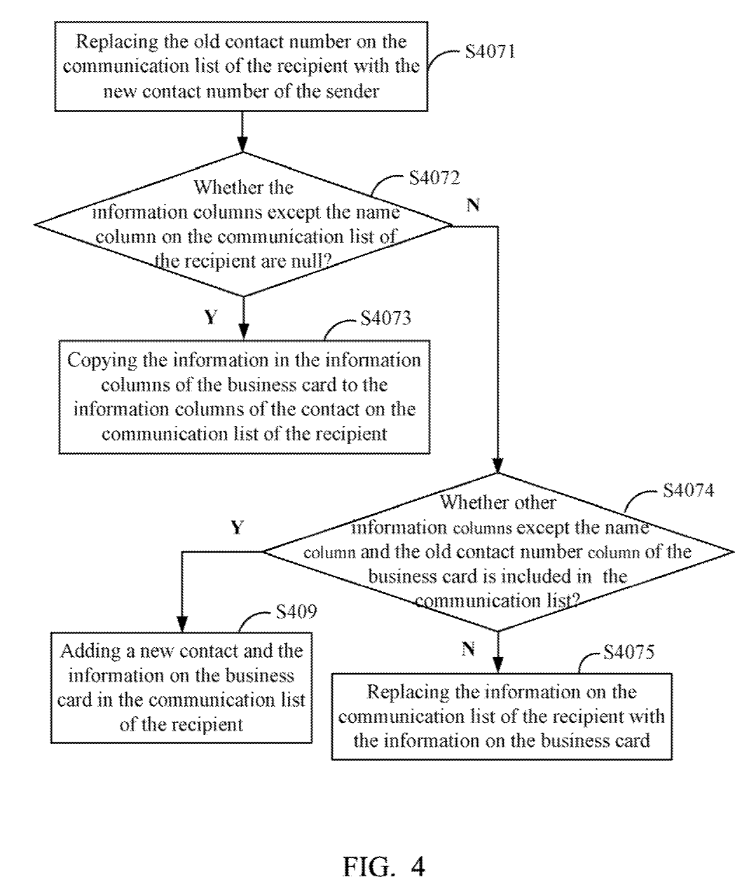

Referring to FIG. 4, a sub-flowchart of the recipient 200 updating the business card sent from the sender 100 between electronic devices of FIG. 3 is shown. The method includes the following steps, each of which is tied to various components contained in the system 10 as shown in FIG. 1.

In step S4071, the second updating module 204 replaces the old contact number on the communication list of the recipient 200 with the new contact number of the sender 100.

In step S4072, the comparing module 203 determines whether the information columns except the name column on the communication list of the recipient 200 are null. If yes, the process goes to step S4073, otherwise, the process goes to step S4074.

In step S4073, the second updating module 204 copies the information in the information columns of the business card to the information columns of the contact on the communication list of the recipient 200.

In step S4074, the comparing module 203 determines whether other information columns except the name column and the old contact number column of the business card is included in the communication list. If yes, the process goes to step S409, otherwise, the process goes to step S4075.

In step S4075, the second updating module 204 replaces the information on the communication list of the recipient 200 with the information on the business card.

With such configuration, when the identifying module 101 determines the SIM card is the first time used for the electronic device, the verifying module 103 prompts the user to input the password and verifies the password. When the password passes the verification of the verifying module 103, the business card edited as the text file is automatically sent by the sending module 105 to the one or more contacts on the communication list of the sender 100. And the second updating module 204 automatically updates the communication list of the recipient 200. Thus it is more convenient for users to send, receive and update the business card.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A system for updating and sending a business card of a sender, comprising:
an input unit configured for a user to fill contact information in contact information columns of the business card;
an identifying module configured for identifying whether the system is used for the first time and;
a template creating module configured for creating a template of the business card when the system is used for the first time;
an updating module configured for filling in new contact information in the contact information columns of the template of the business card according to the user inputs via the input unit, and creating the business card, the business card comprising a new and an old contact number of the sender; and
a sending module configured for sending the business card to one or more contacts via using the SIM card.

2. The system as described in claim 1, wherein the identifying module is further configured for identifying whether the SIM card is being used for the first time with the system, and the system further comprises a verifying module configured for prompting a sender to input a password when a SIM card is being used for the first time with the electronic device, and verifying the password.

3. The system as described in claim 1, wherein the password is preset by the sender, for confirming the authority of sending the business card to the contacts.

4. A system for receiving and updating a business card from a sender, the business card comprising a name, a new number and an old contact number of the sender, the system comprising:
a storing module configured for storing a communication list of a recipient;
a receiving module configured for receiving the business card sent by the sender;
a comparing module configured for determining whether the old contact number in the business card is included in the communication list of the recipients; and
an updating module configured for updating the information in the communication list of the recipient when the old contact number in the business card is included in the communication list of the recipient.

5. The system as described in claim 4, wherein the updating module replaces the old contact number on the communication list of the recipient with the new contact number of the sender when the old contact number in the business card is included in the communication list of the recipient.

6. The system as described in claim 4, wherein the updating module adds a new contact in the communication list of the recipient and records the corresponding information except the old contact number on the business card under the new contact when the old contact number in the business card is not included in the communication list of the recipient.

7. The system as described in claim 5, wherein the comparing module determines whether information columns except the name column on the communication list of the recipient are null, and the updating module copies the information in the information columns of the business card to the information columns of the contact on the communication list of the recipient, when the information columns except the name column are null.

8. The system as described in claim 5, wherein the comparing module determines whether information columns except the name column on the communication list of the recipient are null, and the updating module replaces the information on the communication list of the recipient with the information on the business card, when the information columns except the name column are not null.

9. The system as described in claim 8, wherein the comparing module is further configured for determining whether other information columns except the name column and the old contact number column of the business card is included in the communication list, and transmitting corresponding comparison results to the updating module.

10. The system as described in claim 9, wherein the updating module replaces the other information on the communication list of the recipient with the information on the business card, when the other information columns except the name and the old contact number of the business card is included in the communication list.

11. The system as described in claim 4, wherein the system further comprises a analyzing module configured for converting the information of the business card to recognizable codes of the recipient, and analyzing the information of the information columns.

12. The system as described in claim 4, wherein the updating module is further configured for popping up a dialog box showing the information on the business card of the sender, prompting the recipient to confirm whether to update the communication list.

13. A method for sending, receiving and updating a business card between electronic devices, the business card comprising a new and an old contact number of a sender, the method comprising:
identifing whether the electronic device of a sender is used for the first time;
creating a template of the business card when the electronic device of the sender is used for the first time;
identifying whether a SIM card in the electronic device of the sender is being used for the first time with the electronic device;
prompting the sender to update contact information in the information columns of the template of the business card according to the user inputs, and creating a business card;
sending the business card to one or more contacts via using the SIM card;
determining whether the old contact number in the business card is included in a communication list of the recipients; and
replacing the old contact number on the communication list of the recipient with the new contact number of the sender when the old contact number in the business card is included in a communication list of the recipient.

14. The method as described in claim 13, further comprises the step of adding a new contact in the communication list of the recipient and recording the corresponding information except the old contact number on the business card under the new contact, when the old contact number in the business card is not included in the communication list of the recipient.

15. The method as described in claim 13, further comprises the step of determining whether information columns except the name column on the communication list of the recipient are null, and copying the information in the information columns of the business card to the information columns of the contact on the communication list of the recipient, when the information columns except the name column are null.

16. The method as described in claim 15, further comprises the step of:
determining whether other information columns except the name column and the old contact number column of the business card is included in the communication list; and
replacing the other information on the communication list of the recipient with the information on the business card, when the other information columns except the name column and the old contact number column of the business card is included in the communication list.

17. The method as described in claim 16, wherein the business card further comprises other information of the following: an e-mail and/or a company of the sender.

18. The method as described in claim 13, further comprises the step of converting the information of the business card to the recognizable codes of the recipient, and analyzing the information of the information columns.

19. The method as described in claim 13, further comprises the step of prompting the sender to input a password and verifies whether the password is correct when the SIM card in the electronic device of the sender is being used for the first time with the electronic device.
